(19) United States
(12) Patent Application Publication
(10) Pub. No.: US 2007/0243911 A1
(43) Pub. Date: Oct. 18, 2007

(54) Mobile Terminal

(75) Inventor: Katutoshi Saito, Miyagi (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/571,993

(22) PCT Filed: Nov. 24, 2005
(86) PCT No.: PCT/JP05/21571

§ 371 Date: Jan. 12, 2007

(30) Foreign Application Priority Data
Nov. 24, 2004 (JP) 2004-338832
Nov. 24, 2004 (JP) 2004-338831

(51) Int. Cl. H04M 1/00

(52) U.S. Cl. 455/575.1

(57) ABSTRACT

To provide a cover-changeable cellular telephone which has a sub-display section and automatically adjusts and sets an illumination pattern without involvement of the user's manual adjustment and setting, as well as rendering display quality stable and simplifying operation for changing the cover.

A mobile terminal 100 has a cabinet 21, a cover member which is selected from a plurality of types of cover members and attached to the cabinet 21, an illumination section illuminating outside the cabinet 21, a storage section for storing a plurality of types of illumination patterns for the illumination section, and a control section for causing the illumination section to illuminate according to a preset one of the respective illumination patterns. The terminal further has separate identification means provided on the cover member, wherein, when the cover member is attached to the cabinet 21, the control section selects one from the respective illumination patterns assigned to the identification means.

### TECHNICAL FIELD

The present invention relates to a mobile terminal, wherein an arbitrary one of a plurality of types of cover members is selectively attached to a cabinet.

### BACKGROUND ART

A cellular telephone, which is one of a mobile terminal, has a tendency to seek fashionability, differentiation, novelty, and the like in association with recent, rapid proliferation. As shown in FIG. 15, in order to meet such a demand, there has been proposed a cellular telephone 1, where an arbitrary one of a plurality of types (5a, 5b, 5c) of cover members 5, such as outer jackets, can be attached in a replaceable manner particularly to a cabinet 3 (a so-called cover-changeable-type cellular telephone). Particularly in the case of a two-fold cellular telephone 1 whose main display section becomes invisible when the telephone is folded for carrying, an LED information display section (a sub-display section 7) is often provided on the side opposite the main display section; namely, an outer face 3a of the cabinet 3 which is to be covered with any of the cover members 5a, 5b, and 5c, so that the user can visibly ascertain the number of an incoming call or a time in a folded state.

In such a cellular telephone 1 provided with such a sub-display section 7, when the cabinet 3 is provided with, e.g., the cover member 5b, an illumination section 11 of the sub-display section 7 is visibly covered and protected by a window section 9 formed in the cover member 5b. In some of the cover members 5, transparent materials which are to be fitted to the window section 9 are formed from materials having different light transmittances according to the designs of the cover members 5a, 5b, and 5c (see, e.g., Patent Document 1). Patent Document 1: JP-A-2004-80390

### DISCLOSURE OF THE INVENTION

### Problem to be Solved by the Invention

In the case of the cover-replaceable cellular telephone having the sub-display section, an arbitrary cover member is selected from numerous variations. Further, if an illumination pattern (the brightness or color of an LED, an illumination layout, or the like) of the sub-display section is one specified pattern, a demand for fashionability is not fulfilled. If transparent materials to be fitted to the window section vary, the intensity of transmitted light changes, which may in turn result in variations in display quality. For these reasons, of related-art cover-changeable-type cellular telephones, some enable the user to manually adjust and set an illumination pattern (e.g., the brightness of an LED) assigned to an attached cover member.

However, in the case of the cellular phone which enables manual adjustment and setting of the illumination pattern, when the user changes the cover member every day, laborious manual adjustment and setting are required every time. The user cannot easily enjoy the valuable cover-changeable function with superior display quality.

For instance, as in the case of a cellular telephone 301 shown in FIG. 16, an illumination section 311 illuminates in an illumination pattern of a moon in a cover member 305a designed to exhibit the night sky. The illumination section 311 illuminates in an illumination pattern of a human face in the cover member 305b designed to exhibit the profile of the face. The illumination section 311 illuminates in an illumination pattern of the hands of a clock in a cover member 305c designed to exhibit the clock. If the transparent materials fitted to a window section 309 vary, the intensity of transmitted light changes, which may in turn result in variations in display quality. Therefore, some of the related-art cover-changeable cellular telephones enable the user to manually download and set an illumination pattern (e.g., an LED illumination application) assigned to the attached cover member.

However, in the case of the cellular phone which enables manual download adjustment of the illumination pattern, when the user changes the cover member every day, laborious manual adjustment and setting are required every time. The user cannot easily enjoy the valuable cover-changeable function with superior display quality.

The present invention has been conceived under the circumstances and aims at providing a cover-changeable cellular telephone which has a sub-display section and automatically adjusts and sets an illumination pattern without involvement of the user's manual adjustment and setting, as well as rendering display quality stable and simplifying operation for changing the cover.

### Means for Solving the Problem

A mobile terminal of the present invention for achieving the object corresponds to a mobile terminal comprising a cabinet, a cover member which is selected from a plurality of types of cover members and attached to the cabinet, an illumination section illuminating outside the cabinet, a storage section for storing a plurality of types of illumination patterns for the illumination section, a control section for causing the illumination section to illuminate according to preset one of the respective illumination patterns, and separate identification means provided on the cover member, wherein, when the cover member is attached to the cabinet, the control section selects one from the respective illumination patterns assigned to the identification means.

In this mobile terminal, when the user has changed the cover member, the identification means provided on the cover member is identified by the control section. The control section having identified the identification means selects an illumination pattern assigned to the identified identification means among the plurality of types of illumination patterns stored in the storage section, and the illumination section is illuminated in this illumination pattern.

The mobile terminal of the present invention is characterized in that, when the cover member is attached to the cabinet, the control section diagnoses an identification characteristic of the identification means.

In this mobile terminal, when the cover member is attached, the identification characteristic of the identification means provided on the cover member is read by the control section. The control section having read the identification characteristic compares the read characteristic value with a specified value stored in the storage section to determine whether or not the read characteristic value falls within a predetermined range. When the read characteristic value falls within the specified range, the value is determined to be normal. When the read characteristic value falls outside the specified range, the value is determined to be anomalous.

Further, the mobile terminal of the present invention is characterized in that, when the cover member is attached to the cabinet, the control section causes the illumination section to perform test illumination in one illumination pattern which has been selected in response to the identification means.

In this mobile terminal, when the cover member is attached to the cabinet, the illumination section performs test illumination in the illumination pattern assigned to the identification means provided on the cover member. Consequently, in the case of, e.g., a cover member which requires an illumination pattern of a human face to appear in a window section, if the illumination section exhibits an illumination pattern of a clock when the cover member is attached, occurrence of faulty operation of the identification means or the control section is ascertained.

In the meantime, a mobile terminal of the present invention corresponds to a mobile terminal comprising a cabinet, a cover member which is selected from a plurality of types of cover members and attached to the cabinet, a communication section housed in the cabinet, an illumination section illuminating outside the cabinet, a storage section for storing a plurality of types of illumination patterns for the illumination section, a control section for causing the illumination section to illuminate according to preset one of the respective illumination patterns when the communication section has shifted to a standby condition, and separate identification means provided on the cover member, wherein, when the cover member is attached to the cabinet, the control section causes the communication section to shift to a communication state so as to download a new illumination pattern assigned to the identification means, store the downloaded illumination pattern into the storage section, and select the new illumination pattern.

In this mobile terminal, when the user changes the cover member, the identification means provided on the cover member is identified by the control section. The control section having identified the identification means causes the storage section to download a new illumination pattern assigned to the identification means, to store the thus-downloaded illumination pattern into the storage section, and to select a new illumination pattern to thus cause the illumination section to illuminate.

### Advantages of the Invention

According to the mobile terminal defined in claim 1 of the present invention, the mobile terminal comprises a cover member which is selected from a plurality of types of cover members and attached to a cabinet, an illumination section illuminating outside the cabinet, a storage section for storing a plurality of types of illumination patterns for the illumination section, and a control section for causing the illumination section to illuminate according to preset one of the respective illumination patterns. The mobile terminal further comprises separate identification means provided on the cover member. When the cover member is attached to the cabinet, the control section selects one from the respective illumination patterns assigned to the identification means. Accordingly, every time the user replaces the cover member, the control section automatically selects an illumination pattern in response to the cover member, thereby obviating complicated manual adjustment and setting. Consequently, stable display quality and simplification of cover-changeable operation can be attained concurrently. The user can easily enjoy the cover-changeable function with superior display quality.

According to the mobile terminal defined in claim 2 of the present invention, when the cover member is attached to the cabinet, the control section diagnoses an identification characteristic of the identification means. First, when the cover member is attached, the identification means is diagnosed as to whether or not the identification means provided on the cover member has a predetermined characteristic. Accordingly, occurrence of an erroneous setting of the control section setting the illumination section in an erroneous illumination pattern, which would otherwise be caused by the identification means having failed to exhibit a predetermined characteristic for reasons of secular deterioration, can be prevented.

According to the mobile terminal defined in claim 3 of the present invention, when the cover member is attached to the cabinet, the control section causes the illumination section to perform test illumination in one illumination pattern which has been selected in response to the identification means. For instance, in the case of the cover member requiring an illumination pattern of a human face to appear in a window section, if the illumination pattern of the clock appears in the illumination section when the cover member is attached, occurrence of faulty operation of the identification means or the control section is ascertained. Consequently, simultaneous with attachment of the cover member, the user can ascertain whether or not the illumination pattern is the predetermined illumination pattern.

According to the mobile terminal defined in claim 4 of the present invention, the mobile terminal comprises a cover member which is selected from a plurality of types of cover members and attached to a cabinet, a communication section housed in the cabinet, an illumination section illuminating outside the cabinet, a storage section for storing a plurality of types of illumination patterns for the illumination section, and a control section for causing the illumination section to illuminate according to a preset one of the respective illumination patterns when the communication section has shifted to a standby condition. The mobile terminal further comprises separate identification means provided on the cover member, wherein, when the cover member is attached to the cabinet, the control section causes the communication section to shift to a communication state, to thus download a new illumination pattern assigned to the identification means, to store the downloaded illumination pattern into the storage section, and to select the new illumination pattern. Every time the user replaces the cover member, the control section automatically downloads the illumination pattern assigned to the cover member, and the thus-downloaded illumination pattern can be illuminated as a new illumination pattern. Therefore, complicated manual download and setting become obviated, and stable display quality and simplification of operation of changing the cover member can be achieved simultaneously. The user can easily enjoy the cover-changeable function with superior display quality.

### BRIEF DESCRIPTION OF THE DRAWINGS

FIG. 1 A perspective view showing a cellular telephone which is a communication terminal of a first embodiment of the present invention.

FIG. 2 A front view of an upper cabinet shown in FIG. 1 when viewed from the exterior surface thereof.

FIG. 3 A perspective view of the cellular telephone from which a cover member of the first embodiment has been removed.

FIG. 4 A perspective view of the cover member of the first embodiment.

FIG. 5 A block diagram showing a control circuit section of the first embodiment.

FIG. 6 A flowchart showing procedures of illumination pattern control of the first embodiment.

FIG. 7 A flowchart showing diagnostic procedures of a diagnostic function of the first embodiment.

FIG. 8 A perspective view showing a cellular telephone which is a communication terminal of a second embodiment of the present invention.

FIG. 9 A front view of an upper cabinet shown in FIG. 8 when viewed from the exterior surface thereof.

FIG. 10 A perspective view of the cellular telephone from which a cover member of the second embodiment has been removed.

FIG. 11 A perspective view of the cover member of the second embodiment.

FIG. 12 A block diagram showing a control circuit section of the second embodiment.

FIG. 13 A flowchart showing procedures of illumination pattern control of the second embodiment.

FIG. 14 A flowchart showing diagnostic procedures of a diagnostic function of the second embodiment.

FIG. 15 A descriptive view of a related-art cellular telephone having a replaceable cover member.

FIG. 16 is a descriptive view of the related-art cellular telephone having a replaceable cover member.

### DESCRIPTIONS OF THE REFERENCE NUMERALS

21, 221 CABINET
37, 237 COVER MEMBER
49, 249 ILLUMINATION SECTION
57, 257 CONTROL SECTION
59, 259 STORAGE SECTION
100, 200 CELLULAR TELEPHONE (MOBILE TERMINAL)
261 COMMUNICATION CIRCUIT SECTION (COMMUNICATION SECTION)
263 SERVER
R2 RESISTANCE (IDENTIFICATION MEANS)

### BEST MODES FOR IMPLEMENTING THE INVENTION

Preferred embodiments of a mobile terminal according to the present invention will be described hereinbelow by reference to the drawings.

### FIRST EMBODIMENT

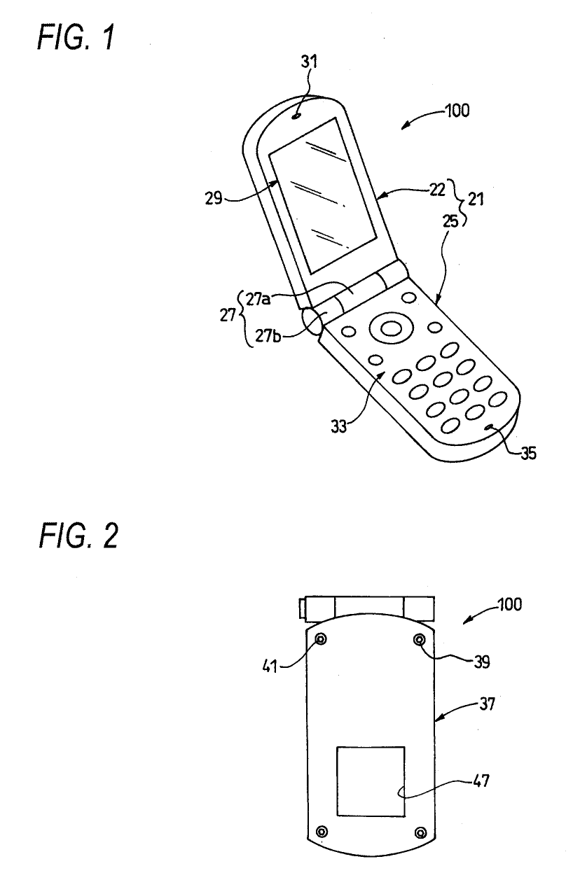

FIG. 1 is a perspective view showing a cellular telephone which is a communication terminal of a first embodiment of the present invention.

The first embodiment is described while a case where the mobile terminal corresponds to a cellular telephone is taken as an example. However, the present invention is not limitedly applied to this case but can also be applied to all of mobile terminals in which any of a plurality of cover members is selectively, removably attached to a cabinet having a display section. In a cellular telephone (a folder type cellular telephone) 100, which is a communication terminal, a cabinet 21 is formed from an upper cabinet 23 and a lower cabinet 25. The upper cabinet 23 and the lower cabinet 25 are made foldable into a two-fold with a hinge section 27 which is formed from a hinge 27a provided on one cabinet and a hinge 27b provided on the other cabinet.

A liquid-crystal display section 29 and an earpiece section 31 are provided in the back of the upper cabinet 23 (a face which is overlaid on the other face). An operation section 33 and a mouthpiece section 35 are provided in the back of the lower cabinet 25. In addition, an antenna, a camera section, a vibrator, and a circuit board having various types of circuit sections, all of which are unillustrated, are provided in the cabinet 21.

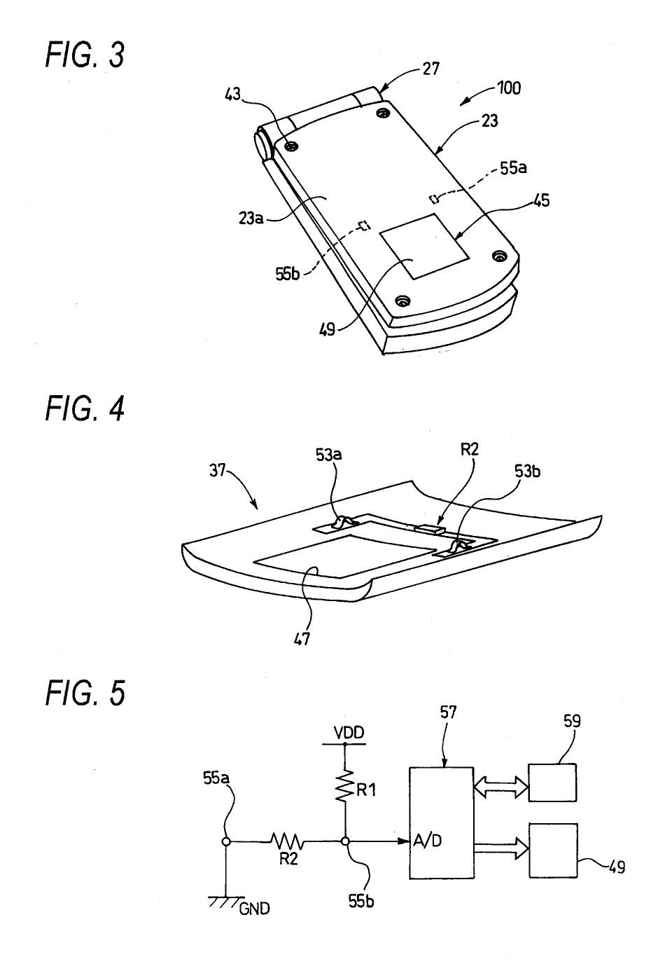

FIG. 2 is a front view of an upper cabinet shown in FIG. 1 when viewed from the exterior surface thereof, and FIG. 3 is a perspective view of the cellular telephone from which a cover member has been removed.

In the cellular telephone 100, a cover member 37, which is an exterior panel, is removably attached to the exterior surface of the upper cabinet 23. The cover member 37, which is an arbitrary one selected among a plurality of types of cover members, is attached in a replaceable (selective) manner. Mount holes 39 are formed in four corners of the cover member 37, and mount screws 41 inserted into the mount holes 39 are screw-engaged with tapped holes 43 formed in a cover attachment face 23a of the upper cabinet 23 shown in FIG. 3, whereby the cover member 37 is attached to the upper cabinet 23.

In the two-fold cellular telephone 100 in which a liquid-crystal section 29, which is a main display section, becomes invisible when the telephone is folded, an LED information display section (a sub-display section 45) for enabling visual ascertainment of the number of an incoming call and a time in a folded state is provided in the opposite face of the liquid-crystal display section 29; i.e., an outer face of the upper cabinet 23 on which the cover member 37 is to be attached (i.e., the cover attachment face 23a).

In the cellular telephone 100, as a result of the cover member 37 being attached to the exterior face of the upper cabinet 23, an illumination section 49 of the sub-display section 45 is visibly covered with and protected by a transparent member fitted to the window section 47 of the cover member 37. The illumination section 49 may be a single luminescent face or a two-dimensional array of a plurality of LEDs. In the cover member 37, a transparent member of the window section 47 may be formed from a material whose light transmittance varies according to the design of the cover member 37.

FIG. 4 is a perspective view of the cover member of the first embodiment.

A resistor R2, which is separate identification means, is provided on the back of the cover member 37, and a pair of electrically-continuous contact sections 53a, 53b are provided at electrodes of the resistor R2. The resistance of the resistor R2 varies according to the cover member 37. When the resistance of the resistor R2 is detected, the type of the cover member 37 can be specified. In the first embodiment, although the resistor R2 is provided on the back of the cover member 37, the resistor R2 may be embedded integrally in the cover member 37. Even in such a case, the contact sections 53a, 53b are exposed on the back of the cover member 37.

A pair of cabinet-side contact sections 55a, 55b (see FIG. 3) are provided at positions on the cover attachment face 23a of the upper cabinet 23 corresponding to the contact sections 53a, 53b achieved at the time of attachment of the cover. The contact section 55a, 55b are connected to the control circuit section of the unillustrated circuit board accommodated in the cabinet 21. When the cover member 37 is attached to the cover attachment face 23a of the upper cabinet 23, the contact sections 53a, 53b of the resistor R2 come into contact with the contact sections 55a, 55b of the upper cabinet 23, to thus come into electrical conduction with the control circuit section.

FIG. 5 is a block diagram showing a control circuit section of the first embodiment.

The cellular telephone 100 has a battery, a power circuit section, a communication circuit section, a voice circuit section, the control circuit section, all of which are not illustrated. The power circuit section generates VDD (a positive power voltage) from the power of the battery, and supplies VDD to respective constituent elements which activate various types of functions of the cellular telephone 100 such as a call function. The control circuit section is equipped with a control section 57 formed from an LSI. In addition to being connected with the communication circuit section, the voice circuit section, the operation section 33, and the like, the control section 57 is connected to the illumination section 49, a storage section 59, and a resistor R1. The control section 57 can control an illumination pattern (the brightness, color, luminous pattern, or the like, of an LED) of the illumination section 49. A plurality of illumination patterns are stored in the storage section 59 in accordance with the types of the cover members 37. Procedures of a diagnostic function, which will be described later, are also stored in the storage section 59.

Operation of the cellular telephone 100 having such a configuration will now be described.

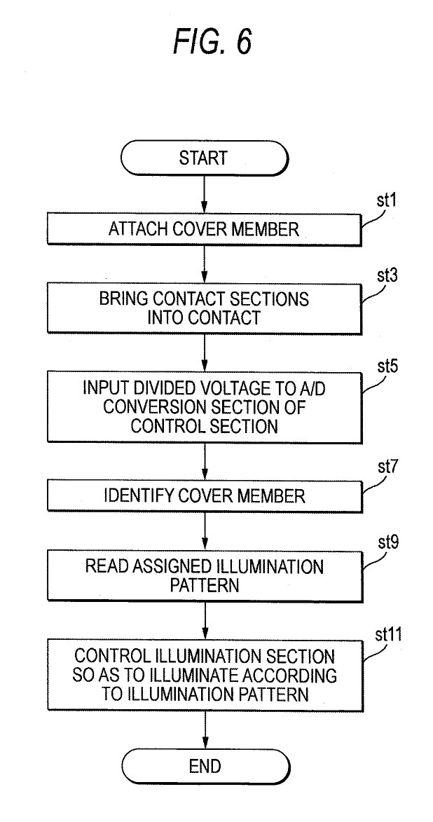

FIG. 6 is a flowchart showing procedures of illumination pattern control of the first embodiment.

In the cellular telephone 100, as a result of the cover member 37 being attached to the cabinet (st1), the contact sections 53a, 53b of the cover member 37 contact the contact sections 55a, 55bof the cabinet 21 (st3), whereupon the resistor R2 is connected as a voltage-dividing resistor for VDD. When the resistor R2 is connected as the voltage-dividing resistor for VDD, the voltage, which has been divided by the resistors R1 andR2, enters an A/D conversion section of the control section 57 (st5) . The control section 57 identifies the type of the attached cover member 37 from a change in an input A/D value (st7) . On the basis of the result of identification, the control section 57 reads an illumination pattern (e.g., a preset value of brightness data) assigned to the attached cover member 37 from the storage section 59 (st9), and controls the illumination section 49 so as to illuminate according to an appropriate illumination pattern (brightness) (st11).

In the cellular phone 100, when the cover member 37 is attached to the upper cabinet 23, the control section 57 selects one from the illumination patterns in response to the resistor R2, and controls the illumination section 49 so as to effect illumination on the basis of the selected one illumination pattern. Thereby, display quality is constantly maintained without being influenced by the design or material of the attached cover member 37.

In the above-described embodiment, the resistance, which generates an identification signal, is input to and identified by the A/D conversion section of the control section 57. In addition, the identification signal may also be identified by means of a port input or discrimination operation performed by a comparator.

Consequently, the cellular telephone 100 has the cover member 37 which is selected from a plurality of types of cover members and attached to the cabinet 21, the illumination section 49 which illuminates outside the cabinet 21, the storage section 59 for storing a plurality of types of illumination patterns of the illumination section 49, and the control section 57 for causing the illumination section 49 to illuminate in accordance with a preset one among the illumination patterns. The cellular telephone 100 further comprises the separate resistor R2 provided on the cover member 37. When the cover member 37 is attached to the cabinet 21, the control section 57 selects one from the illumination patterns in response to the resistor R2. Hence, every time the user replaces the cover member 37, the control section 57 automatically selects the illumination pattern assigned to the cover member 37, whereby complicated manual adjustment and setting become unnecessary. Consequently, stable display quality and simplification of operation of changing the cover member can be achieved simultaneously. The user can easily enjoy the cover-changeable function with superior display quality.

A preferable diagnostic function added to the cellular telephone 100 will now be described.

This diagnostic function is stored in the storage section 59 in the form of, e.g., a program, and executed by the control section 57.

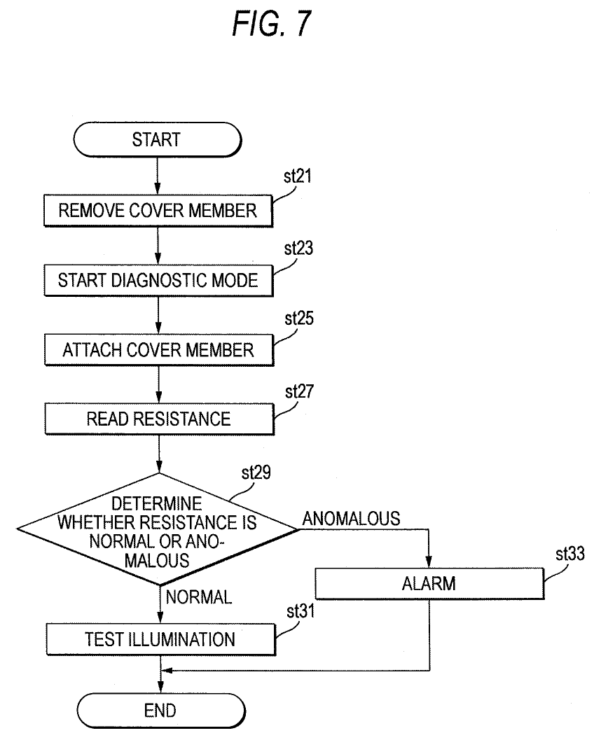

FIG. 7 is a flowchart showing diagnostic procedures of a diagnostic function of the first embodiment.

For instance, in the cellular telephone 100, when the cover member 37 is removed from the cabinet (st21), the resultant-divided voltage triggers the control section 57 to enter a diagnostic mode where the resistor R2 is diagnosed according to the diagnostic program stored in the storage section 59 (st23).

Next, when the cover member 37 is attached to the cabinet 21 (st25), the control section 57 reads the identification characteristic (resistance) of the resistor R2 mounted on the cover member 37 (st27).

The control section 57 having read the resistance compares the thus-read resistance with a specified value stored in the storage section 59 to thus determine whether or not the resistance falls within a predetermined range (st29).

When the thus-read resistance falls within the predetermined range, the control section 57 determines the resistance to be normal, and causes procedures to proceed to test illumination (st31). In contrast, when the read resistance falls outside the predetermined range, the control section 57 determines the resistance to be abnormal, and emits an alarm (st33)

When the read resistance falls within the predetermined range, the control section 57 effects test illumination. In connection with test illumination, the control section 57 causes the illumination section 49 to effect test illumination in one illumination pattern selected according to the resistance R2. Consequently, for example, in the case of the cover member 37 which requires an illumination pattern of a human face to appear in the window section 47, if the illumination pattern of a clock appears in the illumination section 49 when the cover member 37 is attached, occurrence of a faulty operation of the resistor R2 or the control section 57 is ascertained.

In connection with the diagnostic function, there has been described the embodiment where test illumination is effected after diagnosis of the resistor R2. As a matter of course, the diagnostic function may effect diagnosis of solely the resistor R2 or individually effect only test illumination.

Consequently, in the cellular telephone 100 of the first embodiment having such a diagnostic function, the control section 57 diagnoses the resistance of the resistor R2 when the cover member 37 is attached to the cabinet 21. Accordingly, occurrence of an erroneous setting of the control section 57 setting the illumination section 49 in an erroneous illumination pattern, which would otherwise be caused by the resistor R2 failed to exhibit a predetermined characteristic for reasons of secular deterioration, can be prevented.

When the cover member 37 is attached to the cabinet 21, the control section 57 causes the illumination section 49 to effect test illumination in one illumination pattern selected in response to the resistor R2. Hence, occurrence of faulty operation of the resistor R2 or the control section 57 is ascertained simultaneously with attachment of the cover member 37, so that an assembly operator or the user can readily ascertain whether or not a predetermined illumination pattern is displayed.

### SECOND EMBODIMENT

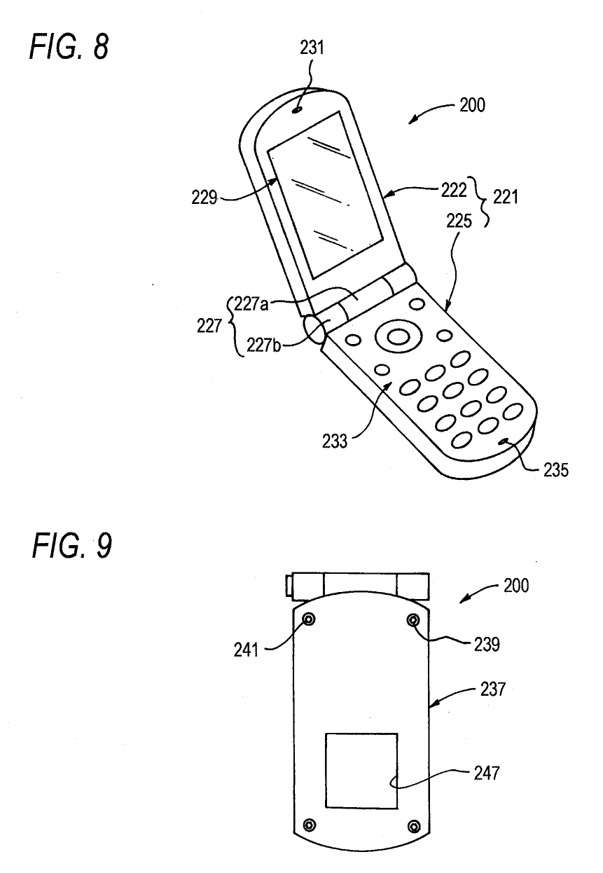

FIG. 8 is a perspective view showing a cellular telephone 200 which is a communication terminal of a second embodiment of the present invention.

The second embodiment is described while a case where the mobile terminal 200 corresponds to a cellular telephone is taken as an example. However, the present invention is not limitedly applied to this case but can also be applied to all of mobile terminals in which any of a plurality of cover members is selectively, removably attached to a cabinet having a display section. In the cellular telephone (a folder type cellular telephone) 200, which is a communication terminal, a cabinet 221 is formed from an upper cabinet 223 and a lower cabinet 225. The upper cabinet 223 and the lower cabinet 225 are made foldable into a two-fold with a hinge section 227 which is formed from a hinge 227a provided on one cabinet and a hinge 227b provided on the other cabinet.

A liquid-crystal display section 229 and an earpiece section 231 are provided in the back of the upper cabinet 223 (a face which is overlaid on the other face). An operation section 233 and a mouthpiece section 235 are provided in the back of the lower cabinet 225. In addition, an antenna, a camera section, a vibrator, and a circuit board having various types of circuit sections, all of which are unillustrated, are provided in the cabinet 221.

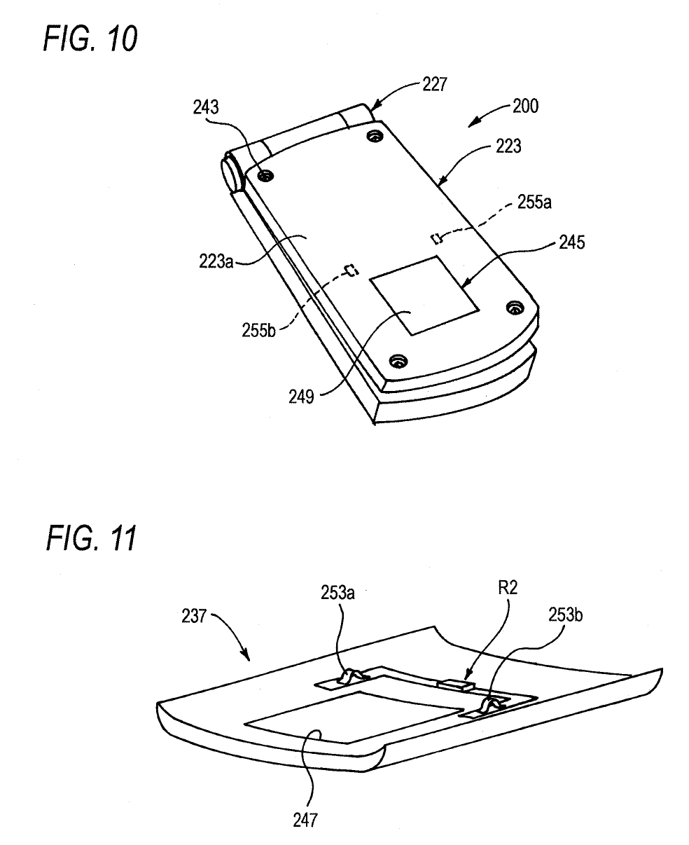

FIG. 9 is a front view of an upper cabinet shown in FIG. 8 when viewed from the exterior surface thereof, and FIG. 10 is a perspective view of the cellular telephone from which a cover member has been removed.

In the cellular telephone 200, a cover member 237, which is an exterior panel, is removably attached to the exterior surface of the upper cabinet 223. The cover member 237, which is an arbitrary one selected among a plurality of types of cover members, is attached in a replaceable (selective) manner. Mount holes 239 are formed in four corners of the cover member 237, and mount screws 241 inserted into the mount holes 239 are screw-engaged with tapped holes 243 formed in a cover attachment face 223a of the upper cabinet 223 shown in FIG. 10, whereby the cover member 237 is attached to the upper cabinet 223.

In the two-fold cellular telephone 200 in which a liquid-crystal section 229, which is a main display section, becomes invisible when the telephone is folded, an LED information display section (a sub-display section 245) for enabling visual ascertainment of the number of an incoming call and a time in a folded state is provided in the opposite face of the liquid-crystal display section 229; i.e., an outer face of the upper cabinet 223 on which the cover member 237 is to be attached (i.e., the cover attachment face 223a).

In the cellular telephone 200, as a result of the cover member 237 being attached to the exterior face of the upper cabinet 223, an illumination section 249 of the sub-display section 245 is visibly covered with and protected by a transparent member fitted to the window section 247 of the cover member 237. The illumination section 249 may be a single luminescent face or a two-dimensional array of a plurality of LEDs. In the cover member 237, a transparent member of the window section 247 may be formed from a material whose light transmittance varies according to the design of the cover member 237.

FIG. 11 is a perspective view of the cover member 237 of the second embodiment.

The resistor R2, which is separate identification means, is provided on the back of the cover member 237, and a pair of electrically-continuous contact sections 253a, 253b are provided at electrodes of the resistor R2. The resistance of the resistor R2 varies according to the cover member 237. When the resistance of the resistor R2 is detected, the type of the cover member 237 can be specified. In the second embodiment, although the resistor R2 is provided on the back of the cover member 237, the resistor R2 may be embedded integrally in the cover member 237. Even in such a case, the contact sections 253a, 253b are exposed on the back of the cover member 237.

A pair of cabinet-side contact sections 255a, 255b (see FIG. 10) are provided at positions on the cover attachment face 223a of the upper cabinet 223 corresponding to the contact sections 253a, 253b achieved at the time of attachment of the cover.

The contact sections 255a, 255b are connected to the control circuit section of the unillustrated circuit board accommodated in the cabinet 221. When the cover member 237 is attached to the cover attachment face 223a of the upper cabinet 223, the contact sections 253a, 253b of the resistor R2 come into contact with the contact sections 255a, 255b of the upper cabinet 223, to thus come into electrical conduction with the control circuit section.

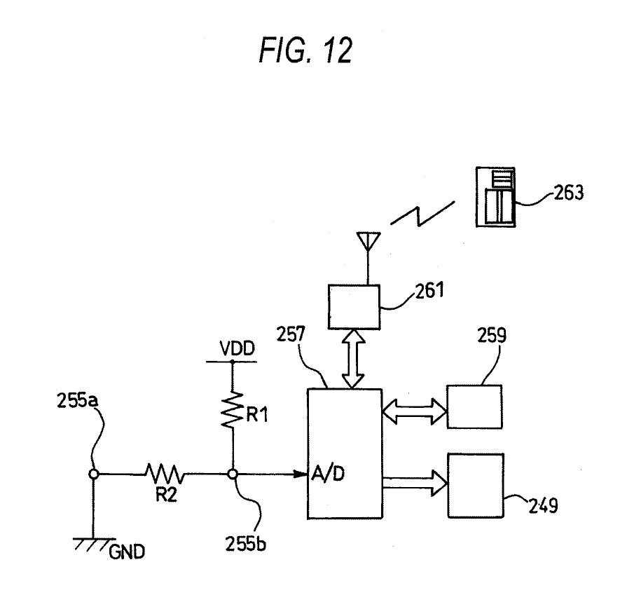

FIG. 12 is a block diagram showing a control circuit section of the second embodiment.

The cellular telephone 200 has a battery, a power circuit section, a communication section (a communication circuit section 261), a voice circuit section, the control circuit section. The power circuit section generates VDD (a positive power voltage) from the power of the battery, and supplies VDD to respective constituent elements which activate various types of functions of the cellular telephone 200 such as a call function. The control circuit section is equipped with a control section 257 formed from an LSI. In addition to being connected with the voice circuit section, the operation section 233, and the like, the control section 257 is connected to the illumination section 249, a storage section 259, a resistor R1, and the communication circuit section 261. The control section 257 can control an illumination pattern (the brightness, color, luminous pattern, or the like, of an LED) of the illumination section 249. A plurality of illumination patterns (an LED illumination application) are stored in the storage section 259 in accordance with the types of the cover members 237. Procedures (a block) of a diagnostic function, which will be described later, are also stored in the storage section 259.

This storage section 259 is divided into a ROM region and a RAM region, and known illumination patterns (an LED illumination application) are stored in the ROM region at the factory before shipment. A new LED illumination application prepared after shipment can be stored in the RAM region. The control section 257 controls reading of data from the ROM region and reading and writing of data from and to the RAM region.

In FIG. 12, reference numeral 263 designates a server (a database server) in the communication network. A plurality of LED illumination applications are accumulated in the server 263, and the server 263 can provide an arbitrary one of the applications via the communication network. Although only one server 263 is illustrated, a plurality of servers may separately provide the respective applications. The control section 257 controls the communication circuit section 261 to thus transmit to the server 263 through wireless communication a command for downloading a desired LED illumination application, and stores the LED illumination application transmitted via the server 263 in the RAM region of the storage section 259. The control section 257 can determine whether the resistance of the resistor R2 is known or new.

Operation of the cellular telephone 200 having such a configuration will now be described.

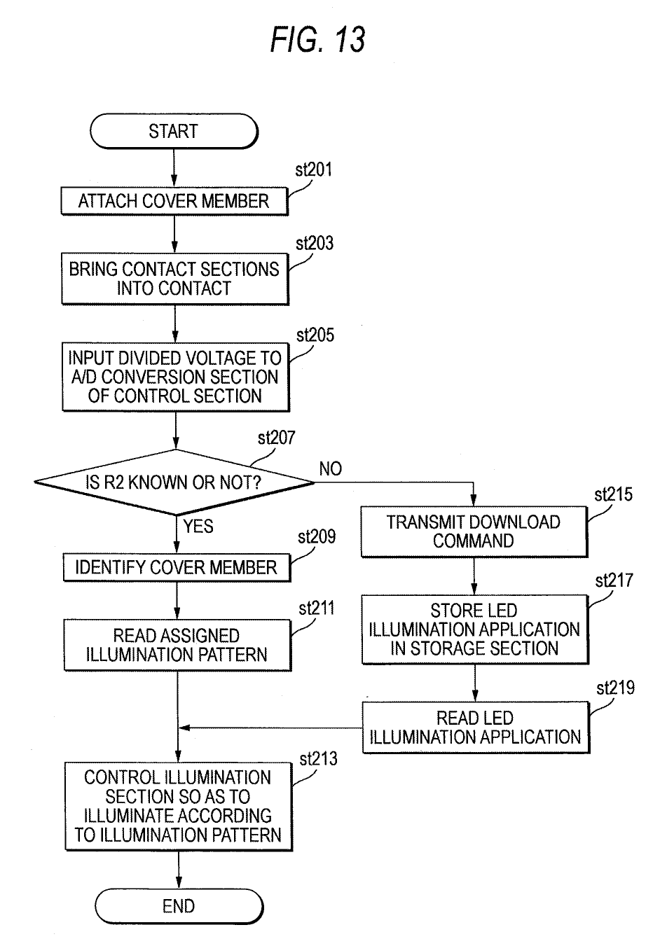

FIG. 13 is a flowchart showing procedures of illumination pattern control of the second embodiment.

In the cellular telephone 200, as a result of the cover member 237 being attached to the cabinet (st201), the contact sections 253a, 253b of the cover member 237 contact the contact sections 255a, 255b of the cabinet 221 (st203), whereupon the resistor R2 is connected as a voltage-dividing resistor for VDD. When the resistor R2 is connected as the voltage-dividing resistor for VDD, the voltage, which has been divided by the resistors R1 and R2, enters an A/D conversion section of the control section 257 (st205).

The control section 257 determines whether or not the resistor R2 is known from a change in the input A/D value (st207). When the resistorR2 is known, the control section 257 ascertains the attachment of the cover member 237 on the basis of the change in the input A/D value (st209). On the basis of the result of ascertainment, the control section 257 reads an LED illumination application assigned to the attached cover member 237 from the ROM region of the storage section 259 (st211), and controls the illumination section 249 to so as to illuminate according to an appropriate illumination pattern (st213).

In contrast, when the resistor R2 has been determined to be new in procedure st207, a command for downloading a desired LED illumination application is transmitted to the server 263 along with the resistance information via the communication circuit section 261 (st215). Next, the control section 257 stores the LED illumination application, which has been transmitted via the server 263, into the RAM region of the storage section 259 (st217). The control section 257 reads the LED illumination application from the RAM region (st219), and controls the illumination section 249 so as to illuminate according to an appropriate illumination pattern through processing analogous to that mentioned previously (st213).

In the cellular phone 200, when the cover member 237 is attached to the upper cabinet 223, the control section 257 first determines whether or not the resistor R2 is known, selects one from the illumination patterns in response to the resistor R2 when the resistor R2 is known, and controls the illumination section 249 so as to effect illumination on the basis of the selected one illumination pattern. In the meantime, when the resistor R2 is new, an illumination pattern is downloaded, and the illumination section 249 is controlled so as to effect illumination on the basis of the illumination pattern. Thereby, display quality is constantly maintained without being influenced by the design or material of the attached cover member 237.

In the above-described embodiment, the resistance, which generates an identification signal, is input to and identified by the A/D conversion section of the control section 257. In addition, the identification signal may also be identified by means of a port input or discrimination operation performed by a comparator.

The above embodiment has described a case where the known LED illumination applications are stored in the storage section 259, all of the known and new LED illumination applications may also be downloaded.

Consequently, the cellular telephone 200 has the cover member 237 which is selected from a plurality of types of cover members and attached to the cabinet 221, the communication circuit section 261 housed in the cabinet 221, the illumination section 249 which illuminates outside the cabinet 221, the storage section 259 for storing a plurality of types of illumination patterns of the illumination section 249, the storage section 259 for storing a plurality of types of illumination patterns for the illumination section 249, and the control section 257 for causing the illumination section 249 to illuminate in accordance with a preset one among the illumination patterns when the communication circuit section 261 has shifted to a standby state. The cellular telephone 200 further comprises the separate resistor R2 provided on the cover member 237. When the cover member 237 is attached to the cabinet221, the control section257 causes the communication circuit section 261 to enter a communication state, whereupon a new illumination pattern assigned to the resistor R2 is downloaded and stored in the storage section 259. Thus, a new illumination pattern is selected. Accordingly, every time the user replaces the cover member 237, the control section 257 can automatically select an illumination pattern assigned to the cover member 237, thereby obviating complicated manual download and setting. Consequently, stable display quality and simplification of operation of changing the cover member can be achieved simultaneously. The user can easily enjoy the cover-changeable function with superior display quality.

A preferable diagnostic function added to the cellular telephone 200 will now be described.

This diagnostic function is stored in the storage section 259 in the form of, e.g., a program, and executed by the control section 257.

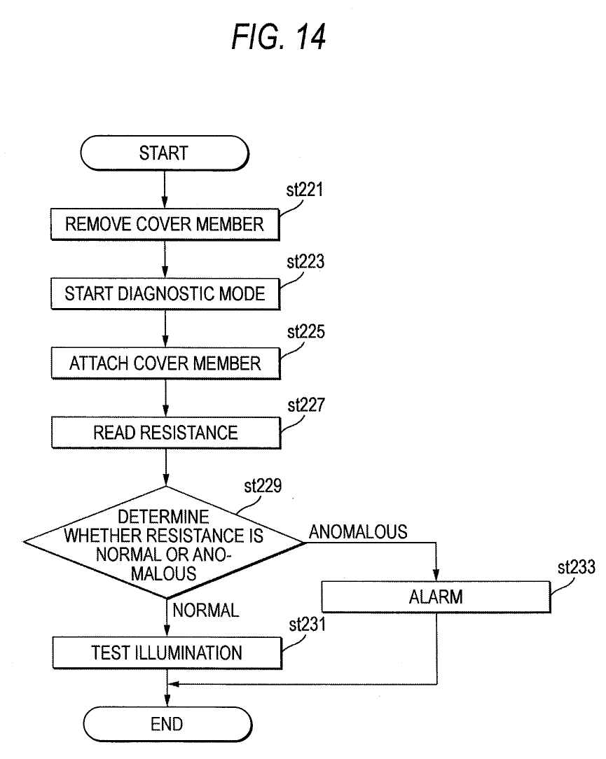

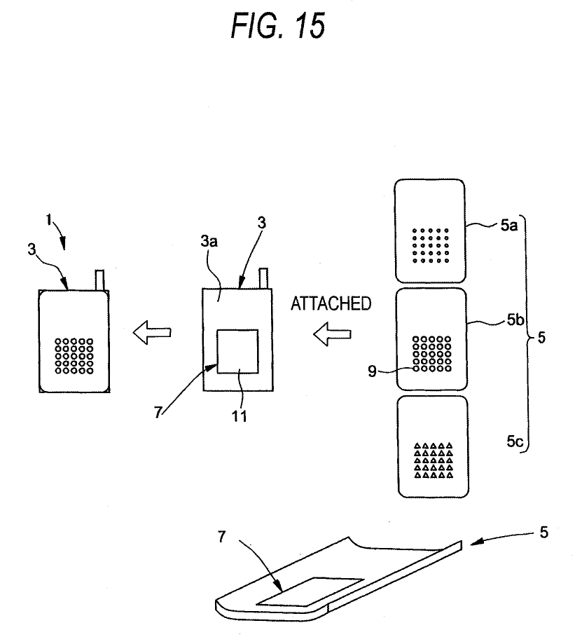

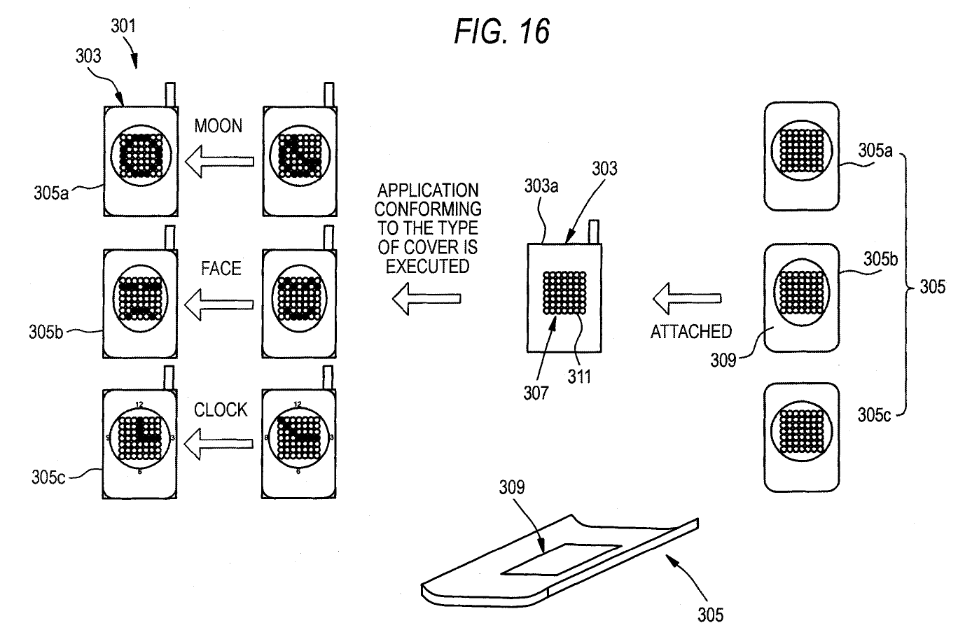

FIG. 14 is a flowchart showing diagnostic procedures of a diagnostic function.

For instance, in the cellular telephone 200, when the cover member 237 is removed from the cabinet (st221), the resultant-divided voltage triggers the control section 257 to enter a diagnostic mode where the resistor R2 is diagnosed according to the diagnostic program stored in the storage section 259 (st223).

Next, when the cover member 237 is attached to the cabinet 221 (st225), the control section 257 reads the identification characteristic (resistance) of the resistor R2 mounted on the cover member 237 (st227).

The control section 257 having read the resistance compares the thus-read resistance with a specified value stored in the storage section 259 to thus determine whether or not the resistance falls within a predetermined range (st229).

When the thus-read resistance falls within the predetermined range, the control section 257 determines the resistance to be normal, and causes procedures to proceed to test illumination (st231). In contrast, when the read resistance falls outside the predetermined range, the control section 257 determines the resistance to be abnormal, and emits an alarm (st233).

When the read resistance falls within the predetermined range, the control section 257 effects test illumination. In connection with test illumination, the control section 257 causes the illumination section 249 to effect test illumination in one illumination pattern selected according to the resistance R2. Consequently, for example, in the case of the cover member 237 which requires an illumination pattern of a human face to appear in the window section 247, if the illumination pattern of a clock appears in the illumination section 249 when the cover member 237 is attached, occurrence of a faulty operation of the resistor R2 or the control section 257 is ascertained.

In connection with the diagnostic function, there has been described the embodiment where test illumination is effected after diagnosis of the resistor R2. As a matter of course, the diagnostic function may effect diagnosis of solely the resistor R2 or individually effect only test illumination.

Consequently, according to the cellular telephone 200 of having such a diagnostic function, the control section 257 diagnoses the resistance of the resistor R2 when the cover member 237 is attached to the cabinet 221. Accordingly, occurrence of an erroneous setting of the control section 257 setting the illumination section 249 in an erroneous illumination pattern, which would otherwise be caused by the resistor R2 having failed to exhibit a predetermined characteristic for reasons of secular deterioration, can be prevented.

When the cover member 237 is attached to the cabinet 221, the control section 257 causes the illumination section 249 to effect test illumination in one illumination pattern selected in response to the resistor R2. Hence, occurrence of faulty operation of the resistor R2 or the control section 257 is ascertained simultaneously with attachment of the cover member 237, so that an assembly operator or the user can readily ascertain whether or not a predetermined illumination pattern is displayed.

The present application claims Japanese Patent Applications (JP-A-2004-338831 and JP-A-2004-338832), filed on Nov. 24, 2004, and which are incorporated herein by reference in their entirety.

1. A mobile terminal comprising:
a cabinet;
a cover member which is selected from a plurality of types of cover members and attached to the cabinet;
an illumination section illuminating outside the cabinet;
a storage section for storing a plurality of types of illumination patterns for the illumination section;
a control section for causing the illumination section to illuminate according to a preset one of the respective illumination patterns; and
a separate identification unit provided on the cover member,
wherein, when the cover member is attached to the cabinet, the control section selects one from the respective illumination patterns assigned to the identification unit.

2. The mobile terminal according to claim 1, wherein, when the cover member is attached to the cabinet, the control section diagnoses an identification characteristic of the identification unit.

3. The mobile terminal according to claim 1, wherein, when the cover member is attached to the cabinet, the control section causes the illumination section to perform test illumination in one illumination pattern in response to the identification unit.

4. A mobile terminal comprising:
a cabinet;
a cover member which is selected from a plurality of types of cover members and attached to the cabinet;
a communication section housed in the cabinet;
an illumination section illuminating outside the cabinet;
a storage section for storing a plurality of types of illumination patterns for the illumination section;
a control section for causing the illumination section to illuminate according to a preset one of the respective illumination patterns when the communication section has shifted to a standby condition; and
a separate identification unit provided on the cover member,
wherein, when the cover member is attached to the cabinet, the control section controls the communications section to shift to a communication state so as to download a new illumination pattern assigned to the identification unit, store the downloaded illumination pattern into the storage section, and select the new illumination pattern.
